(19) United States
(12) Patent Application Publication
(10) Pub. No.: US 2005/0094529 A1
(43) Pub. Date: May 5, 2005

(54) Recording method for a phase change optical disc

(75) Inventors: Kwang Lyul Lee, Seoul (KR); Jin Hong Kim, Yongin-si (KR); Hun Seo, Yongin-si (KR); Seung Yoon Lee, Seoul (KR); Keum Cheol Kwak, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/941,949

(22) Filed: Sep. 16, 2004

(30) Foreign Application Priority Data
Sep. 16, 2003 (KR) 10-2003-0064189
Feb. 3, 2004 (KR) 10-2004-0006989
Mar. 9, 2004 (KR) 10-2004-0015884

(51) Int. Cl. G11B 3/00

(52) U.S. Cl. 369/59.12

(57) ABSTRACT

A recording method for a phase change optical disk is disclosed. To prevent crystalline material from growing at the leading portion of predetermined marks, e.g. marks 4T or more in length, the interval between the first pulse and multi pulses among write pulses for forming marks 4T or more in length is increased by delaying the multi pulses against a reference clock and the widths or levels of the multi pulses are also increased. In another embodiment, to prevent a change in the starting positions of marks due to the increase of the interval between the first pulse and multi pulses, the last pulse among write pulses for forming marks 3T or more in length is advanced by a predefined time period. In still another embodiment, the interval between the first pulse and multi pulses among write pulses for forming marks 4T or more in length is increased and the starting position of the first pulse, the starting position and width of the last pulse, a trailing edge cooling time deviation are individually adjusted depending on the length of marks.

### 1. TECHNICAL FIELD

The present invention relates to a recording method for a phase change optical disk and, more particularly, but not by way of limitation, to a method of adjusting laser write pulses for a phase change optical disk with a view to improving the quality of repeated recording.

### 2.BACKGROUND ART

With the advent of multimedia era that deals with video data including moving or still pictures, audio data, and computer data in an integrating manner, the use of package media such as CDs and DVDs has been dramatically increased and is expected to be on this path. The standardization of new high-density optical disks such as Blu-ray Disc (BD) has been progressing rapidly and new optical disk related products are expected to be commercially available on the market in the near future.

A package medium, e.g., CD, DVD, or BD, comprises a substrate, a recording layer, and a protective layer. A read-only optical disk has pre-pits formed thereon that provide servo/position information and data and has a reflective layer.

A recordable or rewritable optical disk has a recordable dye or a phase change or opto-magnetic recording layer and a protective layer for protecting the recording layer as well as pre-pits and a reflective layer.

Recordable or rewritable optical disks can be used both as audio or video data storage media and as computer data storage media. When an optical disk is used as a computer data storage medium, the optical disk should fulfill much more data rewrites than used as a video or audio data storage medium.

For recording and playing back data, the laser beam emitted by a laser diode reaches a reflective layer after passing through an objective lens, a transparent protective layer (polycarbonate substrate of a thickness of 1.2 mm for CD and 0.6 mm for DVD), and a recording layer and the reflected laser beam is collected by a photo diode. In the case of Blu-ray Disc, a blue laser operating at a single wavelength of 405 nm and an objective lens of a high numerical aperture (NA) of 0.85 are used and the protective layer 0.6 mm in thickness is replaced by a cover layer 0.1 mm in thickness.

The recording layer may become either amorphous or crystalline by phase change depending on laser irradiation. Amorphous marks and crystalline spaces show a substantial difference in optical reflectance and so they can be used to represent binary data. A single laser pulse cannot form a well-shaped amorphous mark on a crystalline matrix because of accumulated heat. For this reason, multi pulses as shown in FIG. 1 are commonly used to form amorphous marks.

FIG. 1 illustrates a waveform of conventional write pulses for a phase change optical disk. During recording, the laser output is modulated with three different power levels according to a predefined write strategy. The write power Pw, which is the highest laser power, creates an amorphous state on the recording layer. The erase power Pe, which is the middle power, melts the recording layer and converts it to a crystalline state. The bottom power Pb is the lowest laser power level.

In the figure, FP, LE, MP, LP denotes the first pulse, leading erase power time duration, multi pulses or center pulses, and last pulse, respectively. TE denotes the trailing edge cooling time deviation from the NRZI ending position. For example, 3FT represents the first pulse for 3T marks, 4MP˜8MP represent the multi pulses for 4T˜8T marks, 2TE represent the trailing edge cooling time deviation for 2T marks, 4LP˜8LP represent the last pulse for 4T˜8T marks.

It is known that eutectic-based material used to manufacture BD is growth-dominant and the shape of the amorphous region changes sensitively depending on the width, level, and timing of the write pulses.

FIG. 2a illustrates a waveform of conventional write pulses for forming 2T˜8T marks, in which the rising edge of every MP and LP is synchronized with the rising edge of a reference clock. FIG. 2b illustrates a photograph of 2T˜8T marks formed by the write pulses. The boundary between amorphous and crystalline regions is more distinct in the trailing portion of a mark than the leading portion thereof. Therefore, when a mark is scanned by the laser beam, the trailing portion thereof shows higher optical reflectance difference and as a result yields better jitter than the leading portion.

During the write phase, the recording layer is heated above the melting point and this liquid is then cooled quickly, allowing the atoms to be solidified in an amorphous state. Unless the cooling rate is sufficiently high, crystalline material grows from the boundary, reducing the amorphous region.

The leading portion of a mark formed by conventional write strategies shows reduced amorphous region because the heat from multi pulses (4M˜8MP) following the first pulse (4FP˜8FP) for 4T˜8T marks decreases the cooling rate. As a result, the RF signal generated at the leading portion of a mark (when the laser beam moves from a crystalline region to an amorphous region) is of worse quality than the RF signal generated at the trailing edge of a mark (when the laser beam moves from an amorphous region to a crystalline region), as shown in FIG. 3.

### 3. DISCLOSURE OF INVENTION

In view of the shortcomings of the prior art, it is an object of the present invention to provide a recording method for a rewritable phase change optical disk such as CD-RW, DVD-RW, and BD-RE that is capable of improving recording and playback characteristics.

It is an object of the present invention to provide a recording method for a rewritable phase change optical disk that prevents crystalline material from growing at the leading portion of predetermined marks, e.g. marks 4T or more in length due to the heat from multi pulses.

It is yet another object of the present invention to provide a recording method for a rewritable phase change optical disk that reduces or prevents the inequalities in the beginning positions of marks 2T and 3T in length and marks more than 4T in length resulting from the increase in the interval-between the first pulse and multi pulses for forming marks 4T or more in length.

In one embodiment of the present invention, the interval between a first pulse and multi pulses among write pulses for forming predetermined marks, e.g. marks 4T or more in length is increased within a predefined limit by delaying the leading pulse or all of the multi pulses. Alternatively, the interval between the first pulse and multi pulses can be increased by advancing the first pulse and last pulse among write pulses for forming marks 2T or more in length with multi pulses among write pulses for forming 4T or more in length unchanged. Increasing the interval between the first pulse and multi pluses among write pulses for forming marks 4T or more in length prevents crystalline material from growing at the leading portion of marks 4T or more in length due to the heat from multi pulses. In this case, the widths or levels of the multi pulses are increased to reduce the formation of a neck shape that would be formed at the leading portion of the marks due to the increase of the interval between the first pulse and the multi pulses.

In another embodiment, the inequalities in the beginning positions of marks 2T and 3T in length and marks 4T or more in length resulting from the movement of the leading portion of marks 4T˜8T in length caused by the increase of the interval between the first pulse and multi pulses among write pulses for forming marks 4T or more in length are prevented by advancing the last pulse (3LP) for 3T marks and last pulse (4LP) for marks 4T or more in length by a predefined period t. It is recommended that the predefined period does not exceed (3/16)T.

In still another embodiment, the interval between the first pulse and multi pulses among write pulses for forming marks 4T or more in length is increased within a predefined limit and the starting position of the first pulse, the starting position and width of the last pulse, the trailing edge cooling time deviation are individually adjusted depending on the length of marks. Write pulses for forming marks 4T or more in length are adjusted to have the same starting position of the first pulse, the same starting position and width of the last pulse, the same trailing edge cooling time deviation.

### 4. BRIEF DESCRIPTION OF DRAWINGS

The accompanying drawings, which are included to provide a further understanding of the invention, illustrate the preferred embodiments of the invention, and together with the description, serve to explain the principles of the present invention.

FIG. 1 illustrates a waveform of conventional write pulses for a phase change optical disk;

FIG. 2 illustrates a waveform of conventional write pulses for creating 2T˜8T marks and a photograph of 2T˜8T marks formed by the write pulses;

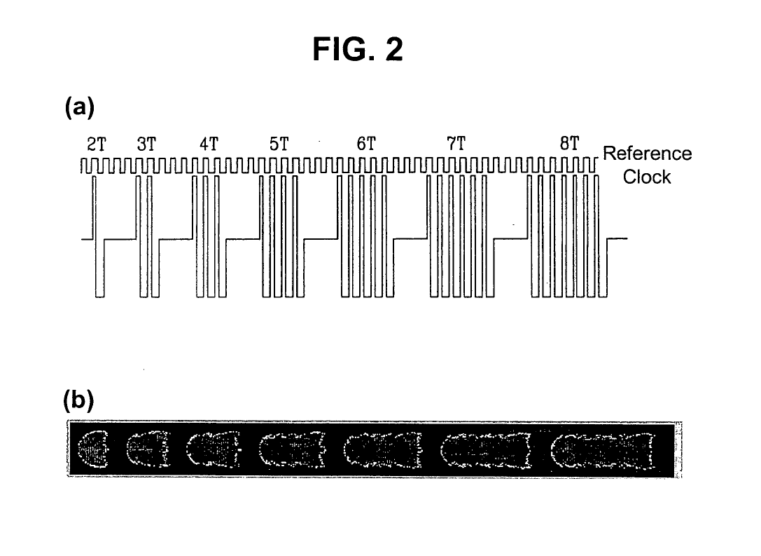

FIG. 3 illustrates an example in which a laser beam scans a space and a mark that follows the space in a phase change optical disk;

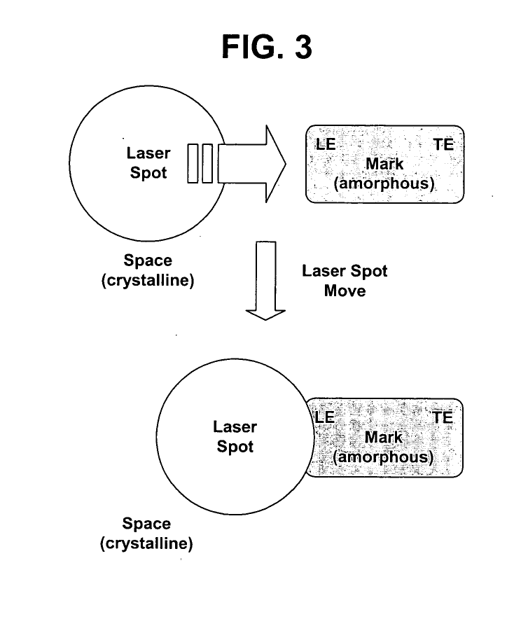

FIG. 4 illustrates a block diagram of an apparatus for adjusting write pulses for a phase change optical disk;

FIG. 5 illustrates a waveform of write pulses for forming 4T˜8T marks, wherein the position of multi pulses is shifted in accordance with an embodiment of the present invention, and a photograph of 2T˜8T marks formed by the write pulses;

FIG. 6 illustrates waveforms of write pulses in accordance with the present invention, wherein the interval between the first pulse and the beginning of the multi pulses is increased, and photographs of marks formed by the write pulses;

FIG. 7 illustrates waveforms of write pulses in accordance with the present invention, wherein the interval between the first pulse and the beginning of the multi pulses is increased and the level of the multi pulses is increased;

FIG. 8 illustrates waveforms of write pulses in accordance with the present invention, wherein the interval between the first pulse and the beginning of the multi pulses is increased by shifting only the first one of the multi pulses;

FIG. 9 illustrates a waveform of write pulses, wherein the multi pulses for forming marks 4T or more in length are delayed and the last pulse for marks 3T or more in length is advanced, and a photograph of marks formed by the write pulses;

FIG. 10 illustrates graphs of jitter versus direct overwrite number obtained by the conventional write pulses and by the write pulses in accordance with the invention;

FIG. 11 illustrates graphs of jitter versus write power obtained by the conventional write pulses and by the write pulses in accordance with the invention;

FIG. 12 illustrates graphs of jitter versus tangential tilt obtained by the conventional write pulses and by the write pulses in accordance with the invention;

FIG. 13 illustrates graphs of jitter versus radial tilt obtained by the conventional write pulses and by the write pulses in accordance with the invention;

FIG. 14 illustrates a cross section of a phase change optical disk;

FIG. 15 illustrates an embodiment of the present invention wherein the positions, widths, and levels of the first pulse, multi pulses, last pulse, and/or trailing edge cooling time deviation for forming each mark are adjusted;

FIG. 16 illustrates the TSMP method in accordance with the present invention, wherein the widths and positions of pulses for forming marks 2T˜9T in length are adjusted;

FIG. 17 illustrates the TSLP method in accordance with the present invention, wherein the widths and positions of pulses for forming marks 2T˜9T in length are adjusted;

FIGS. 18 and 19 illustrate graphs of jitter versus write power with different positions of multi pulses in the TSMP method in accordance with the present invention; and

FIG. 20 illustrates the equality of the TSMP method and TSLP method in accordance with the present invention.

Features, elements, and aspects of the invention that are referenced by the same numerals in different figures represent the same, equivalent, or similar features, elements, or aspects in accordance with one or more embodiments.

### 5. MODES FOR CARRYING OUT THE INVENTION

In order that the invention may be fully understood, preferred embodiments thereof will now be described with reference to the accompanying drawings.

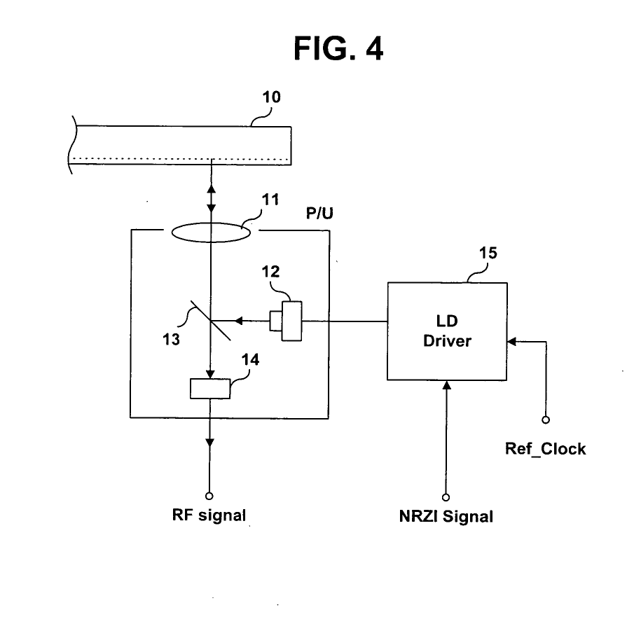

The recording method for a phase change optical disk in accordance with the present invention may be applied to all rewritable phase change optical disks including CD-RW, DVD-RW, BD-RE, etc. As shown in FIG. 4, an optical disk recorder embodying the present invention comprises an objective lens 11, a laser diode 12, a beam splitter 13, a photo detector 14, and an LD driver 15.

The LD driver 15 generates write pulses corresponding to the NRZI signal using a reference clock, ref_clock, and provides the pulses to the laser diode 12, thereby repeatedly forming marks and spaces nT in length corresponding to the NRZI signal (e.g., 2T˜8T) on the recording layer of a phase change optical disk 10.

A first embodiment wherein the position of multi pulses is shifted with a view to improving the quality of RF signal generated at the leading portion of 4T˜8T marks is described.

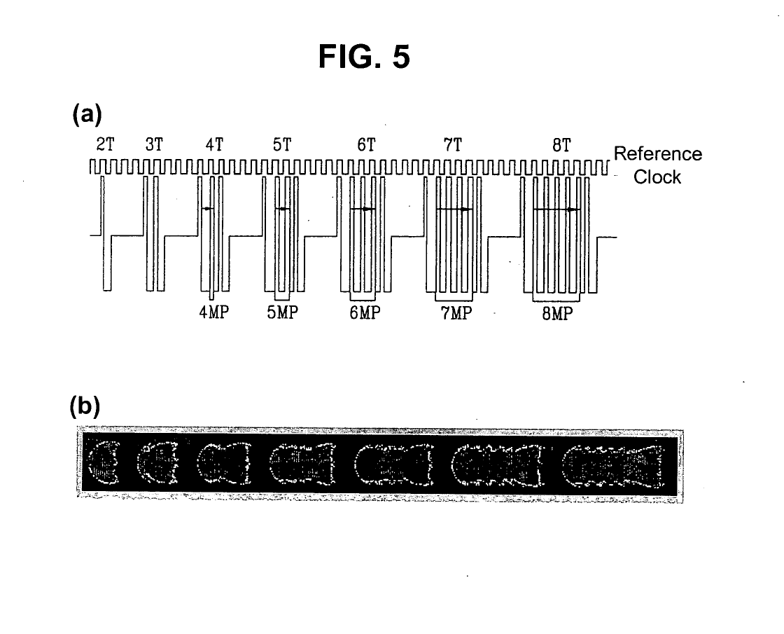

In order to improve the reproduced signal quality, the leading portion of a mark melt by the first pulse needs to be cooled quickly to become amorphous. To this end, multi pulses following the first pulse for 4T˜8T marks are delayed as shown in FIG. 5a. Increasing the interval between the first pulse and the beginning of the multi pulses for forming 4T˜8T marks prevents the leading portion of the marks from being reheated by the multi pulses and thus increases the cooling rate of the leading portion, thereby reducing the growth of crystalline material at the leading portion, as shown in FIG. 5b.

If the NRZI signal corresponds to marks 4T˜8T in length, the LD driver 15 creates write pulses comprising leading erase power time duration (LE), first pulse (FP), multi pulses (MP), last pulse (LP), and trailing edge cooling time deviation (TE), with an increased interval between the first pulse and the beginning of the multi pulses by delaying the multi pulses with a view to preventing crystalline material from growing at the leading portion of the marks by the heat from multi pulses. In addition, the level or width of all or some of the multi pulses is adjusted to compensate for the cooling state after the first pulse with high write power, thereby minimizing the formation of a neck shape that would be formed at the leading portion of the marks due to the increase of the interval between the first pulse and the multi pulses.

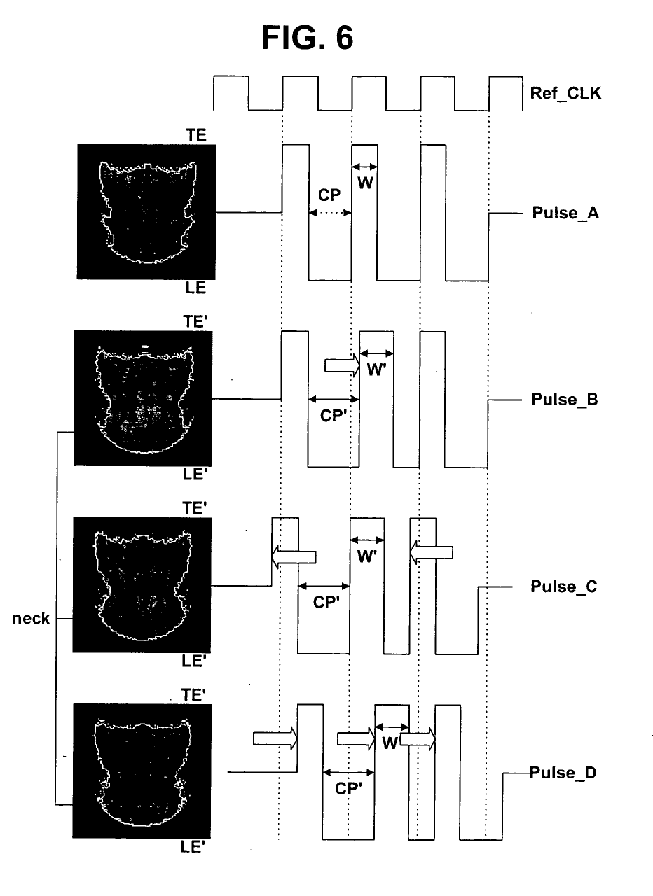

For forming a mark of a length of 4T, a conventional LD driver generates write pulses Pulse_A shown in FIG. 6 comprising the first pulse, multi pulses, and the last pulse, wherein the level and width (W) of all pulses are identical and the interval between pulses, i.e., cooing period (CP), is also identical. In this case, the leading portion of the mark is recrystallized by the heat from the multi pluses and thus reduced.

For forming a mark of a length of 4T, the LD driver 15 embodying the present invention generates write pulses Pulse_B shown in FIG. 6 comprising the first pulse, multi pulses, and the last pulse, wherein the multi pulses are shifted to increase the interval between the first pulse and the beginning of the multi pulses and the width of each multi pulse (W′>W) is increased.

As a result, the cooling period is extended (CP′>CP), which prevents crystalline material from growing at the leading portion of marks due to the heat from multi pulses. In addition, the width of the multi pulses is increased to compensate for the cooling state after the first pulse with high write power, thereby minimizing the formation of the neck shape at the leading portion of the marks.

For forming a mark of a length of 4T, the LD driver 15 embodying the present invention generates write pulses Pulse_C shown in FIG. 6 comprising the first pulse, multi pulses, and the last pulse, wherein the timing for the multi pulses is unchanged but the timing for the first pulse and last pulse is adjusted to increase the interval between the first pulse and the beginning of the multi pulses and the width of each multi pulse (W′>W) is increased.

For forming a mark of a length of 4T, the LD driver 15 embodying the present invention generates write pulses Pulse_D shown in FIG. 6 comprising the first pulse, multi pulses, and the last pulse, wherein the timing for each of the first pulse, multi pulses, and last pulse is adjusted to increase the interval between the first pulse and the beginning of the multi pulses and the width of each multi pulse (W′>W) is increased.

As a result, the cooling period is extended (CP′>CP), which prevents crystalline material from growing at the leading portion of marks due to the heat from multi pulses. In addition, the width of the multi pulses is increased to compensate for the cooling state after the first pulse with high write power, thereby minimizing the formation of the neck shape at the leading portion of the marks.

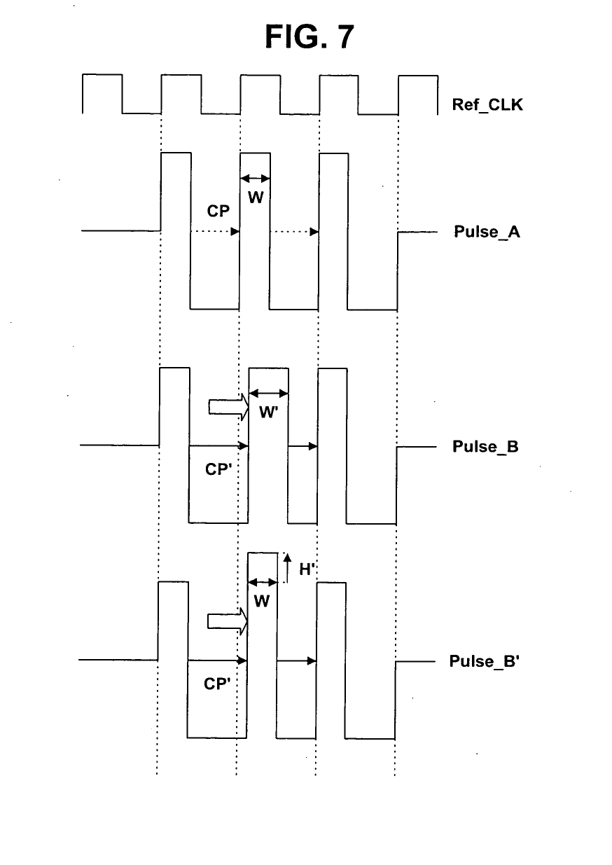

For forming a mark, the LD driver 15 embodying the present invention generates write pulses shown in FIG. 7, wherein the interval between the first pulse and the beginning of the multi pulses is increased, the width of each multi pulse is unchanged, and the level of the multi pulses is increased for obtaining higher write power to compensate for the cooling state after the first pulse with high write power, thereby minimizing the formation of the neck shape at the leading portion of the mark.

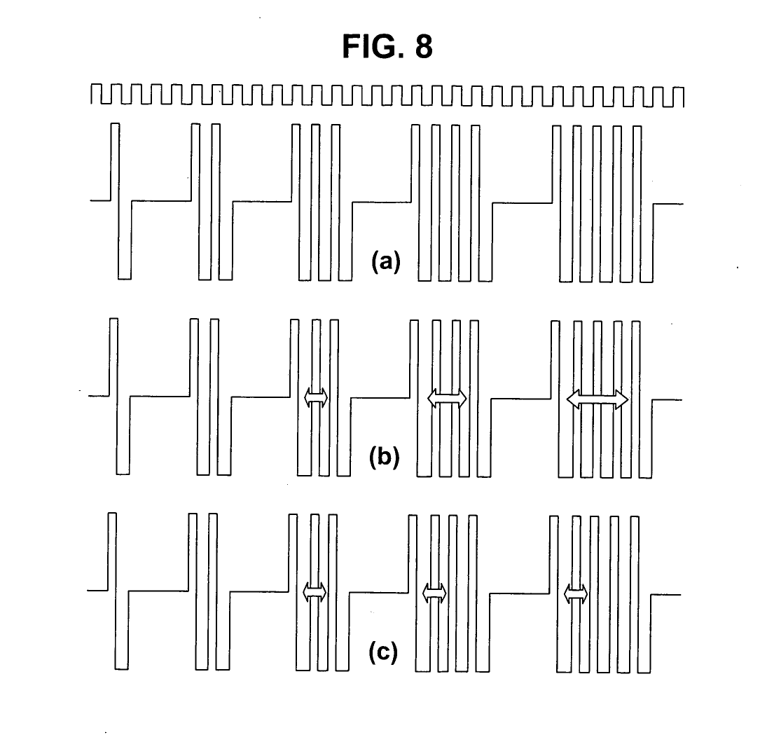

The interval between the first pulse and the beginning of the multi pulses for forming 4T˜8T marks can be increased by shifting only the first one of the multi pulses as shown in FIG. 8(c), instead of delaying all the multi pulses as shown in FIG. 8(b).

When the interval between the first pulse and the beginning of the multi pulses for forming marks 4T or more in length is increased to improve reproduced signal quality at the leading portion of the marks, the area of amorphous marks 4T or more in length increases in such a way that the leading portion of the marks moves in the opposite direction the laser beam is going on. This makes the marks 2T and 3T in length relatively shorter than marks 4T or more in length, which yields worse jitter property because the starting point of a mark depends on its length.

A second embodiment of the present invention for solving the aforementioned problem of the method that the leading portion of marks 4T or more in length moves in the opposite direction the laser beam is going on will now be described in detail.

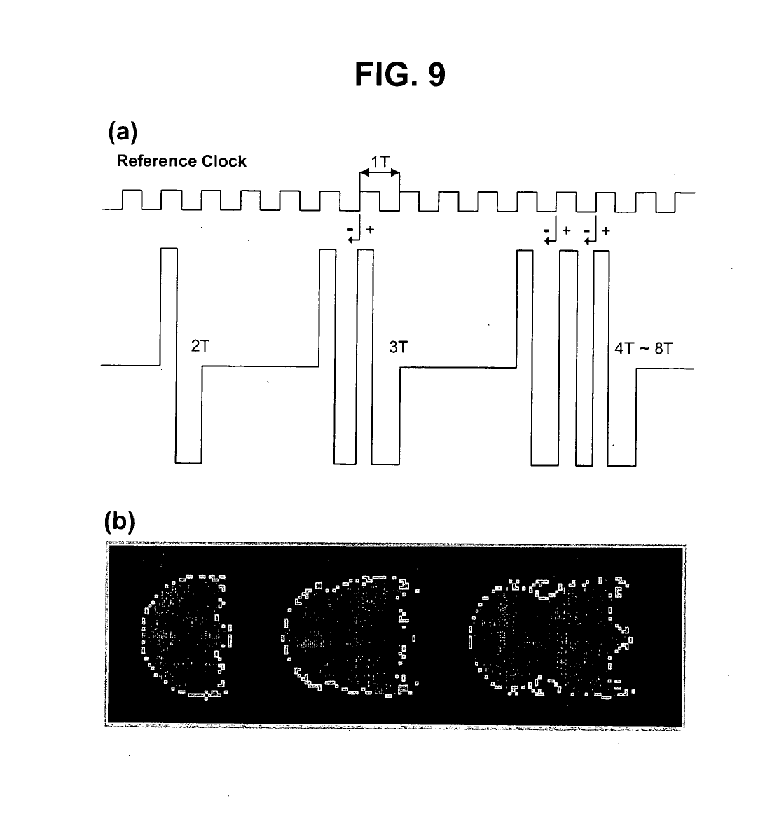

FIG. 9a illustrates write pulses in accordance with the second embodiment and 9b illustrates a photograph of marks formed by the write pulses.

In a second embodiment of the present invention shown in FIG. 9a, the beginning of multi pulses (4MP˜8MP) for forming 4T˜8T marks is delayed so that the multi pulses start after the rising edge of the reference clock therefor and the rising edges of the last pulse (3LP) for 3T marks and last pulse (4LP) for marks 4T or more in length are advanced by a predefined period t (0<t≧3/16T) so that the last pulse precedes the rising edge of the reference clock therefor. A photograph of marks 2T, 3T, and 4T in length formed by the write pulses is shown in FIG. 9b.

The waveform of the write pulses shown in FIG. 9a is one exemplary embodiment of the present invention and therefore the present invention is not limited to it. The beginning of the last pulse only for 3T marks except for marks 4T or more in length may be advanced by a predefined period t (0<t≦3/16T) so that the last pulse precedes the reference clock. In addition, the beginning of the first pulse for 2T and 3T marks may be advanced by a predefined period with shifting the beginning of the last pulse among write pulses for forming marks 3T and/or 4T or more in length.

The aforementioned write pulses compensates for the inequalities in the beginning positions of marks 2T and 3T in length and marks 4T or more in length resulting from the movement of the leading portion of marks 4T or more in length caused by the delay of the multi pulses for forming marks 4T or more in length, thereby yielding better jitter values.

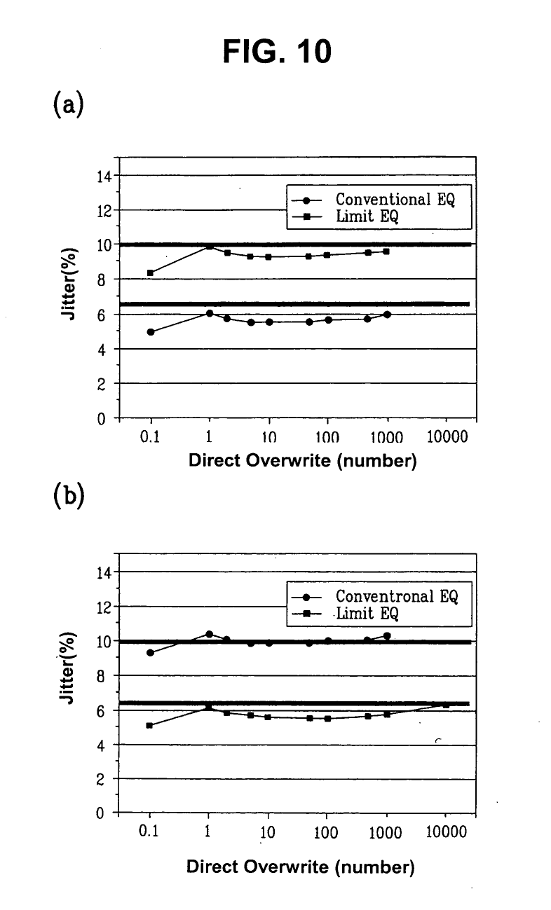

FIGS. 10 through 13 compare the characteristics of phase change optical disks to which conventional recording method is applied and the second embodiment of the present invention is applied. The disk rotation speed is 2× (double of normal speed) and disk recording is performed under the following conditions.

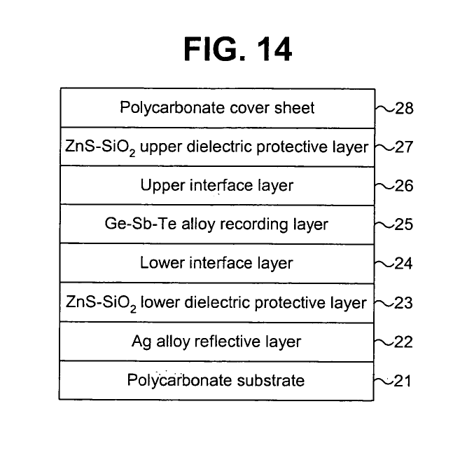

A phase change optical disk comprises many layers as shown in FIG. 14. On a doughnut-shaped polycarbonate substrate 21 having a inner radius of 15 mm, an outer radius of 120 mm, a thickness of 1.1 mm, a track pitch of 0.32 um (including land and groove), are stacked an Ag alloy reflective layer 22, a ZnS—SiO₂ lower dielectric protective layer 23, an lower interface layer 24, a Ge—Sb—Te alloy recording layer 25, an upper interface layer 26, and a ZnS—SiO₂ upper dielectric protective layer 27. A polycarbonate cover sheet 28 of 80 um in thickness is bonded to the multiple layers with UN resin of 20 um in thickness. The optical disk is initialized before use by an initialization apparatus. After initialization, the optical characteristics of the optical disk are evaluated using an optical disk drive and evaluation equipment (e.g., DD-1000 of Pulstec).

The condition under which recording and playback is performed is as follows:
channel bit clock: 132 MHz (1T=7.5757 ns)
linear velocity: 10.56 m/s
disk capacity: 23.3 GB/side
jitter measuring apparatus: TA520 from Yokogawa
sampling: 30,000 samples
read laser power: 0.35 mW
bottom laser power: 0.5 mW
write laser power: 5.2 mW
erase laser power: 1.9 mW

Jitter refers to the deviation of the leading and trailing edges from the reference PLL cock, normalized to the channel bit length (CBL). For jitter measurements, marks and spaces 2T˜8T in length are recorded on a track N times repeatedly and the jitter is measured.

In FIGS. 10 through 13, (a) shows the evaluation result obtained by the write pulses in accordance with the second embodiment of the present invention and (b) shows the evaluation result obtained by the conventional method. In each figure, two limit lines are shown. The 10% line is the jitter limit when a conventional equalizer is used and the 6.5% line is the jitter limit when a limit equalizer is used.

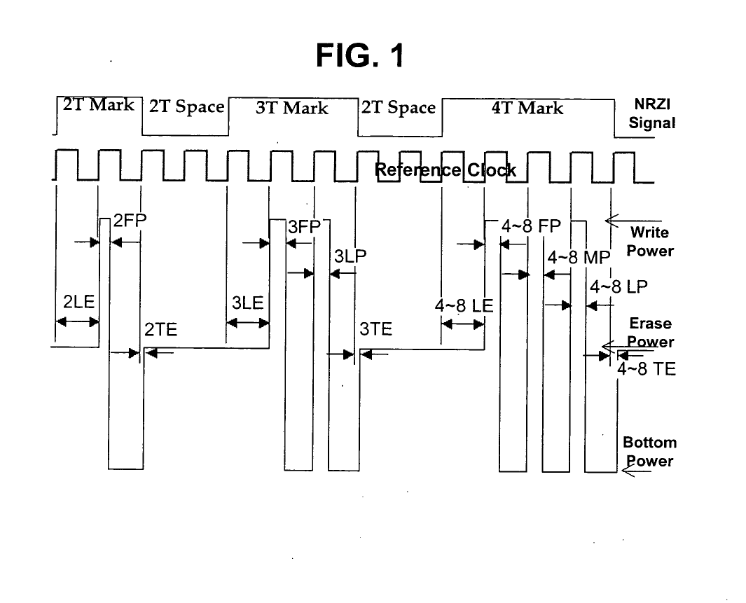

FIG. 10 shows jitter versus direct overwrite number. When evaluated using the conventional equalizer, the jitter obtained by the conventional write pulses shown in FIG. 1 exceeds the 10% limit but the jitter obtained by the write pulses in accordance with the present invention remains below the 10% limit.

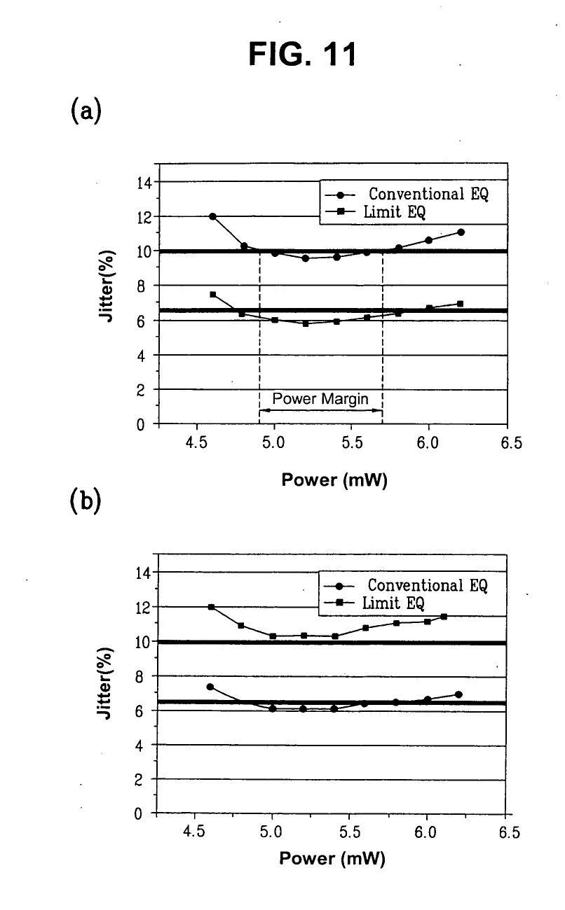

FIG. 11 shows jitter versus write power. When evaluated using the conventional equalizer, the write pulses in accordance with the present invention yield jitter values lower than the 10% limit if the write power is between 4.9 mW and 5.7 mW but the conventional write pulses do not yield jitter values less than 10% with any write power.

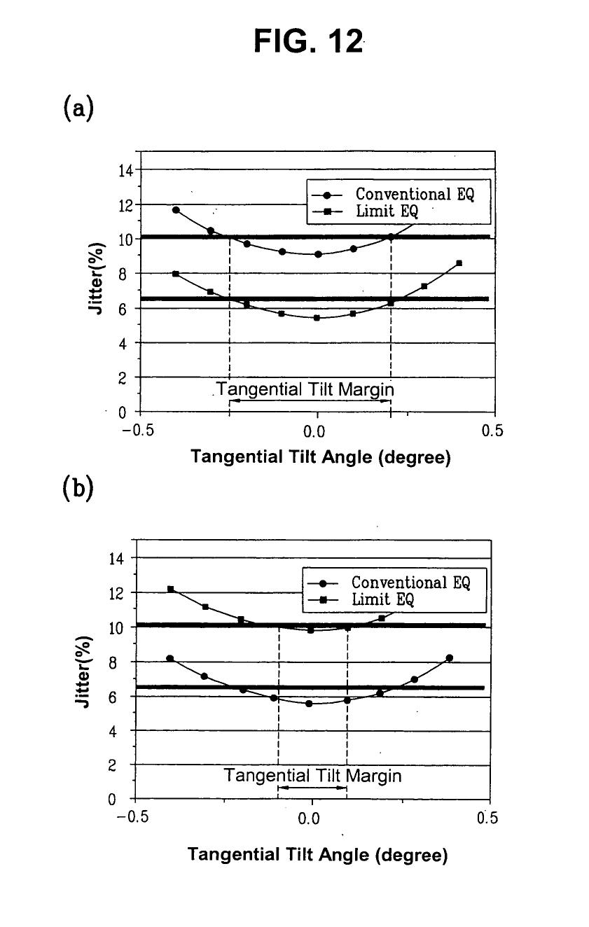

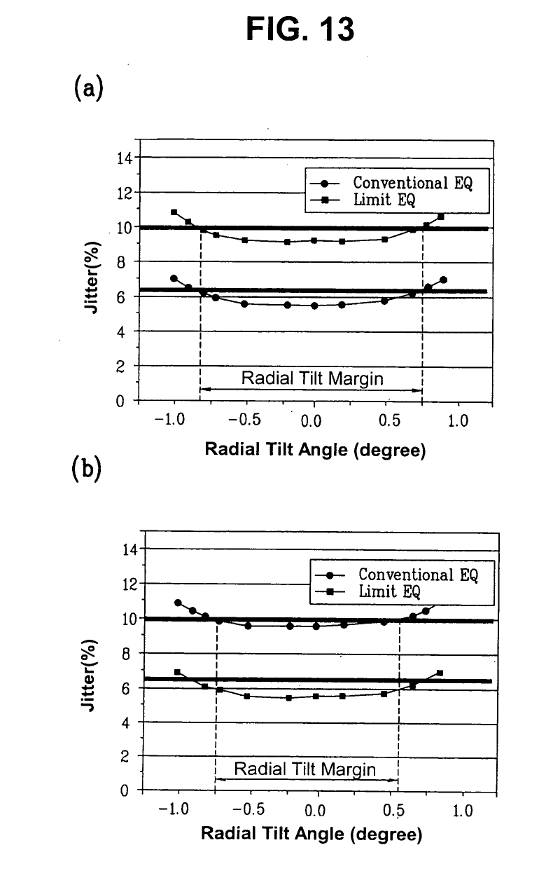

FIGS. 12 and 13 show jitter versus tangential tilt angle and jitter versus radial tilt angle, respectively. The tangential tilt margin, which is the range of tangential tilt angles that yield jitter values less than 10% when evaluated with the conventional equalizer, is −0.25 deg<θ<0.2 deg with the write pulses in accordance with the present invention but is −0.1 deg<θ<0.1 with the conventional write pulses. The radial tilt margin, which is the range of radial tilt angles that yield jitter values less than 10% when evaluated with the conventional equalizer, is −0.8 deg<θ<0.75 deg with the write pulses in accordance with the present invention but is −0.75 deg<θ<0.6 with the conventional write pulses. It is evident that the write pulses in accordance with the present invention yield more tangential and radial tilt margins.

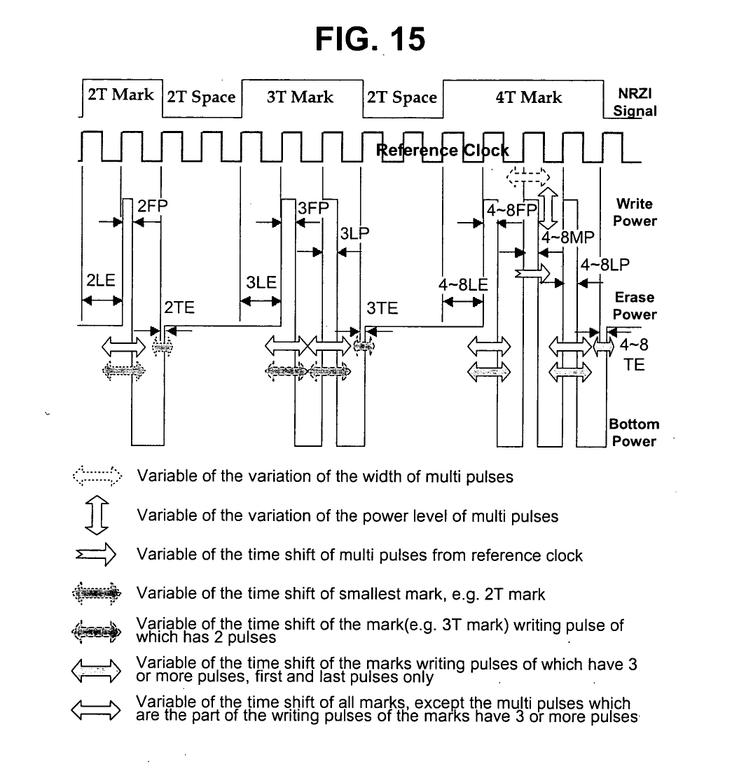

As shown in FIG. 15, the shape of marks 2T and 3T in length can be controlled by adjusting the first pulse, the trailing edge cooling time deviation, and/or the last pulse. Likewise, the first pulse, the last pulse, and/or the trailing edge cooling time deviation for forming marks 4T or more in length can be adjusted individually or simultaneously.

There are two possible ways to adjust write pulses for forming marks of 2T˜8T in length for controlling the shape of resultant marks. One is to shift the timing of the multi pulses for forming marks 4T or more in length against the reference clock and the other is to shift the timing of the last pulse and/or first pulse with the multi pulse timing unchanged.

In the timing shift of multi pulses (TSMP) method, the timing of the multi pulses (MP) existing between the first pulse (FP) and the last pulse (LP) for forming marks 4T or more in length is adjusted to control the shape of resultant marks. For example, the area of amorphous material around the leading edge of the marks is guaranteed to be greater than a predefined value.

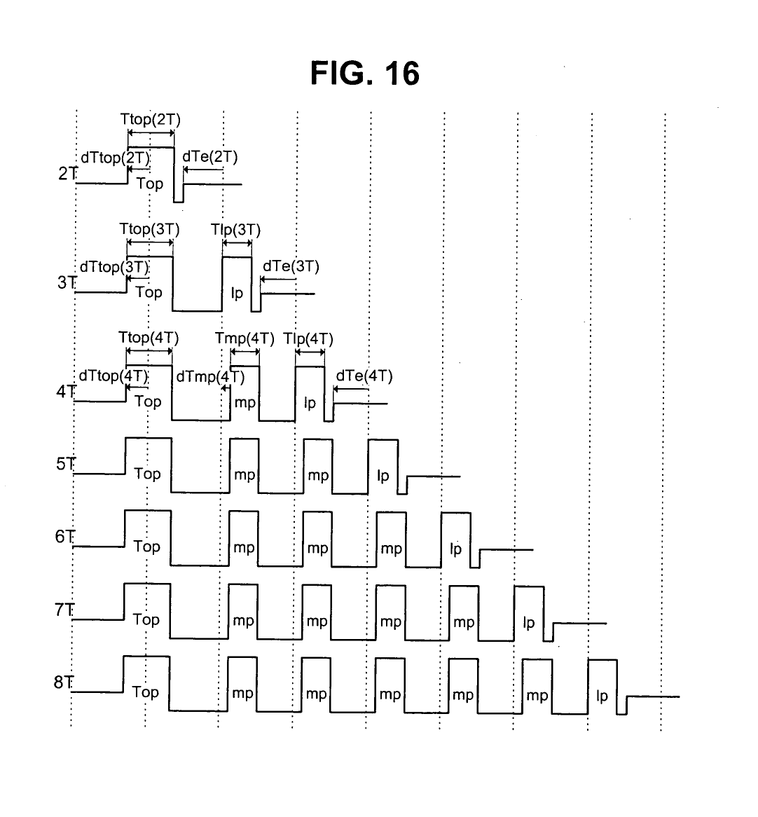

As shown in FIG. 16, in the timing shift of multi pulses (TSMP) method the width and timing of pulses for forming marks 2T˜8T or 9T in length are set and especially the timing of the multi pulses is adjusted variably.

The position of the first pulse, dTtop, can be expressed as dTtop=i*(T/16), i=−16, −15, . . . , −1, 0, 1, 2, . . . , 15. The value of i may vary depending on the mark length and the same value of i is applied to all the first pulses for forming marks 4T or more in length.

The width of the first pulse, Ttop, can be expressed as Ttop=j*(T/16)+k*(1 ns), j, k=0, . . . , 15, Ttop≧2.5 ns. The value of j and k may vary depending on the mark length and the same values of j and k can be applied to all the first pulses for forming marks 4T or more in length.

The position of the multi pulses existing between the first pulse and the last pulse, dTmp, can be expressed as dTtmp=m*(T/16), m=−16, −15, . . . , −1, 0, 1, 2, . . . , 15. The same value of m is applied to all the multi pulses for forming marks 4T or more in length.

The width of the multi pulses, Tmp, can be expressed as Tmp=p*(T/16)+q*(1 ns), p, q=0, . . . , 15, Tmp≧2.5 ns. The same values of p and q are applied to all the multi pulses for forming marks 4T or more in length.

The width of the last pulse, Tlp, can be expressed as Tlp=s*(T/16)+t*(1 ns), s, t=0, . . . , 15, Tlp≧2.5 ns. The same values of s and t are applied to all the last pluses for forming marks 4T or more in length and different values can be applied to the last pulse for forming a mark 3T in length.

The trailing edge cooling time deviation for forming a space after the last pulse, dTe, can be expressed as dTe=u*(T/16), u=−16, −15, . . . , −1, 0, 1, 2, . . . , 15. The value of u may vary depending on the mark length and the same value of u can be applied to all the trailing edge cooling time deviations for forming marks 4T or more in length.

In the above equations (e.g., dTtop and dTmp), a positive value means that the corresponding pulse comes behind the reference clock and a negative value means that the corresponding pulse precedes the reference clock.

In the timing shift of last pulse (TSLP) method, the timing of the last pulse (LP) among write pulses forming marks 4T or more in length is adjusted to control the shape of resultant marks in such a way that the area of amorphous material around the leading edge of the marks is guaranteed to be greater than a predefined value.

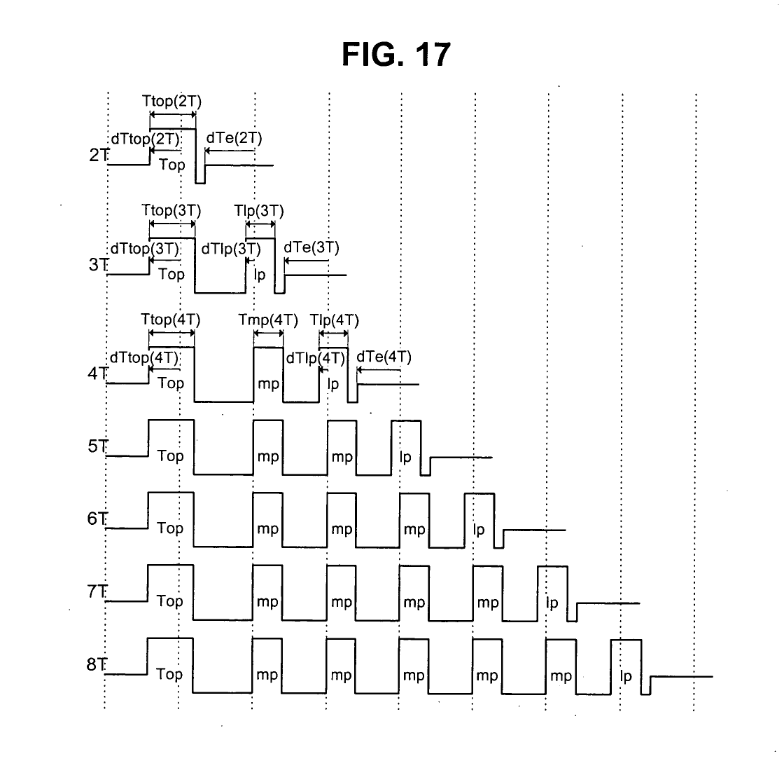

As shown in FIG. 17, in the timing shift of last pulse (TSLP) method the width and timing of pulses for forming marks are set and especially the timing of the last pulse is adjusted variably.

The position of the first pulse, dTtop, can be expressed as dTtop=i*(T/16), i=−16, −15, . . . , −1, 0, 1, 2, . . . , 15. The value of i may vary depending on the mark length and the same value of i is applied to all the first pulses for forming marks 4T or ore in length.

The width of the first pulse, Ttop, can be expressed as Ttop=j*(T/16)+k*(1 ns), j, k=0, . . . , 15, Ttop≧2.5 ns. The values of j and k may vary depending on the mark length and the same values of j and k can be applied to all the first pulses for forming marks 4T or more in length.

The width of the multi pulses, Tmp, can be expressed as Tmp=p*(T/16)+q*(1 ns), p, q=0, . . . , 15, Tmp≧2.5 ns. The same values of p and q are applied to all the multi pulses for forming marks 4T or more in length.

The position of the last pulse, dTlp, can be expressed as dTlp=r*(T/16), r=−16, −15, . . . , −1, 0, 1, 2, . . . , 15. The same value of r is applied to all the last pluses for forming marks 4T or more in length and a different value can be applied to the last pulse for forming a mark 3T in length.

The width of the last pulse, Tlp, can be expressed as Tlp=s*(T/16)+t*(1 ns), s, t=0, . . . , 15, Tlp≧2.5 ns. The same values of s and t are applied to all the last pluses for forming marks 4T or more in length and different values can be applied to the last pulse for forming a mark 3T in length.

The trailing edge cooling time deviation for forming a space after the last pulse, dTe, can be expressed as dTe=u*(T/16), u=−16, −15, . . . , −1, 0, 1, 2, . . . , 15. The value of u may vary depending on the value of T and the same value of u can be applied to all the trailing edge cooling time deviations for forming marks 4T or more in length.

The conditions under which the TSMP method in accordance with the present invention is applied to a rewritable Blu-ray disk (BD-RE) are similar to those in the experiment of the second embodiment. Only the difference, therefore, is described here. The same disk, evaluation equipment, and jitter measuring apparatus are used.

The data is recorded on grooves, which the laser beam reaches sooner than lands, i.e., on-groove recording is employed. The bottom power, write power, erase power are 0.1 mW, 5.2 mW, 3.4 mW, respectively. The laser wavelength, channel bit clock, recording linear velocity, and disk capacity are 408 nm, 133 MHz (1T=7.575 ns), 9.84 m/s, and 25 GB/side, respectively. The data reproduction channel bit clock is 66 MHz and reproduction linear velocity is 4.92 m/s. Data is recorded on five consecutive tracks and the jitter is measured on the third track. The direct overwrite (DOW) jitter is measured in the same manner, but data are recorded on five consecutive tracks repeatedly, e.g., N times and the jitter on the third track is measured after the Nth recording. The recorded data comprises 2T˜8T marks and spaces.

Under the condition that dTmp is set to 0, the parameters that minimize the direct overwrite (DOW) jitter are as follows. For 2T marks, dTtop(2T)=0.5 ns, Ttop(2T)=2.75 ns, and dTe(2T)=1 ns. For 3T marks, dTtop(3T)=0.75 ns, Ttop(3T)=2.75 ns, Tlp(3T)=3.25 ns, and dTe(3T)=0.5 ns. For longer marks, dTtop(≧4T)=0.5 ns, Ttop(≧4T)=3 ns, Tlp(≧4T)=3.25 ns, dTe(≧4T)=1 ns, dTmp(≧4T)=0(+1) ns, and Tmp(≧4T)=3.25 ns.

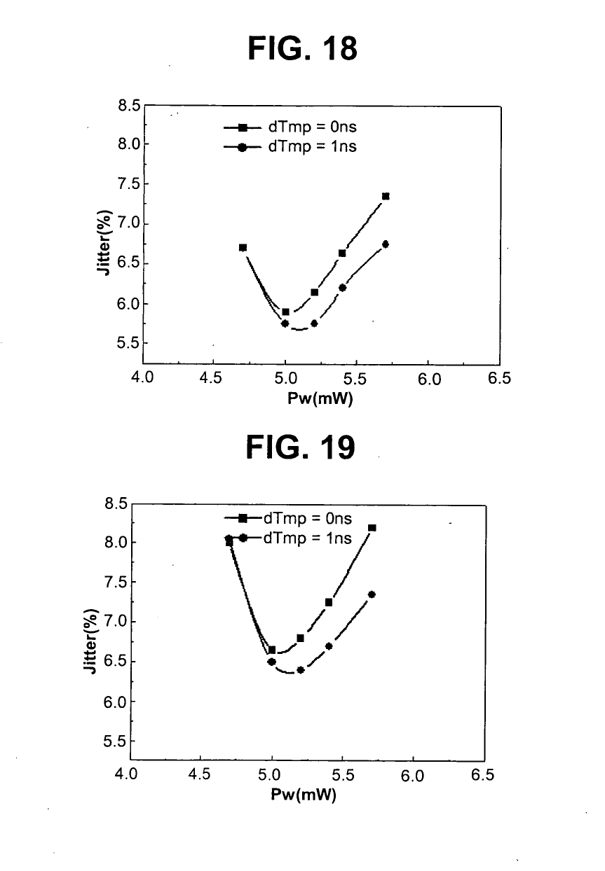

FIGS. 18 and 19 show jitter values versus write power when dTmp is set to +1 ns. The value of +1 ns means that the multi pulses for 4T˜8T marks starts 1 ns later than the rising edge of the reference clock. FIG. 18 shows DOW(1), i.e., the jitter after 1 overwrite and FIG. 19 shows DOW(10). i.e., the jitter after 10 overwrites.

As shown, dTmp of +1 ns yields low jitter values and more write power margin than dTmp of 0 ns. The optimal value of dTmp depends on the characteristics of the recording layer of an optical disk.

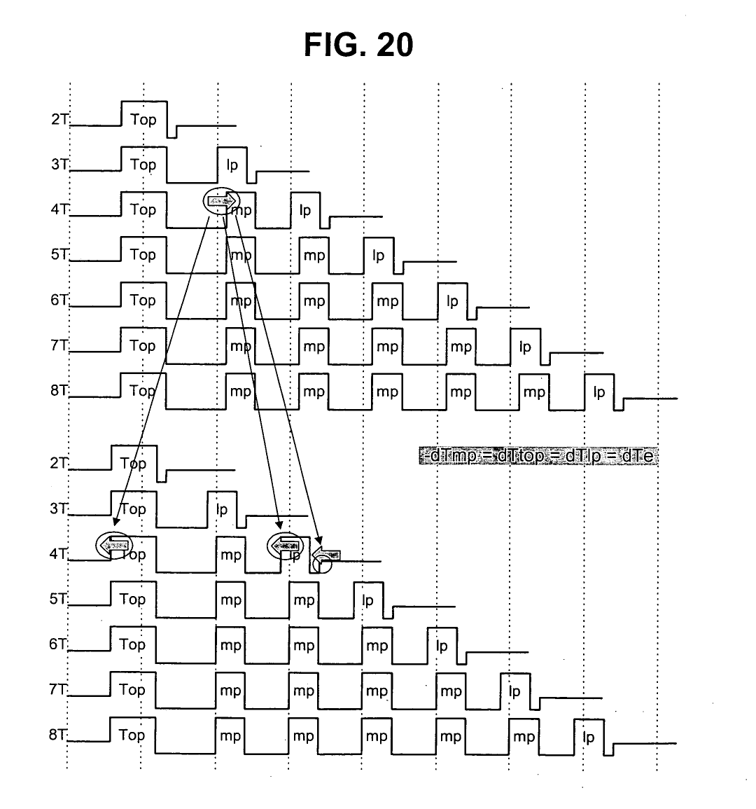

Compared to dTmp=0, positive dTmp means that the multi pulses are close to the last pulse than the first pulse. The effect of negative dTmp in the TSMP method can be achieved by setting dTmp to 0 and dTtop, dTlp, and dTe to negative values in the TSLP method in accordance with the present invention, as shown in FIG. 20.

Write pulse parameters that yield the same effect when dTmp=+1 ns are as follows. For 2T marks, dTtop(2T)=−0.5 ns, Ttop(2T)=2.75 ns, and dTe(2T)=0 ns. For 3T marks, dTtop(3T)=−0.25 ns, Ttop(3T)=2.75 ns, Tlp(3T)=3.25 ns, and dTe(3T)=−0.5 ns. For longer marks, dTtop(≧4T)=−0.5 ns, Ttop(≧4T)=3 ns, Tlp(≧4T)=3.25 ns, dTe(≧4T)=0 ns, dTmp(≧4T)=0 ns, and Tmp(≧4T)=3.25 ns.

The recording method for a phase change optical disk in accordance with the present invention effectively prevents the leading portion of the marks from being reheated by the multi pulses, thereby reducing the growth of crystalline material at the leading portion of marks 4T or more in length.

The recording method for a phase change optical disk in accordance with the present invention effectively prevents jitter increase resulting from the shift of multi pulses to improve the quality of signals reproduced at the leading portion of marks 4T or more in length.

The recording method for a phase change optical disk in accordance with the present invention improves the recording/reproduction characteristics in a phase change rewritable optical disk by adjusting the timing and width of write pulses.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A recording method for a phase change optical disk, wherein the interval between a first pulse and multi pulses among write pulses for forming predetermined marks in length is increased within a predefined limit if the write pulses for forming each mark comprise pulses the number of which is one less than the corresponding mark length.

2. The method set forth in claim 1, wherein the multi pulses are adjusted so that one or more pulses of the multi pulses including the leading pulse of the multi pulses among the write pulses for forming predetermined marks in length, respectively, starts behind the rising edge of the reference clock therefor.

3. The method set forth in claim 1, wherein the multi pulses are adjusted so that all of the multi pulses among the write pulses for forming predetermined marks in length, respectively, start behind the rising edge of the reference clock therefor.

4. The method set forth in claim 2, wherein the widths or levels of the multi pulses that start behind the rising edge of the reference clock therefor are increased.

5. The method set forth in one of claims 2 through 4, wherein a last pulse among write pulses for forming a mark 3T in length is adjusted so that the last pulse starts a predefined period ahead of the rising edge of the reference clock therefor.

6. The method set forth in claim 5, wherein a last pulse among write pulses for forming marks 4T or more in length is adjusted so that the last pulse starts a predefined period ahead of the rising edge of the reference clock therefor.

7. The method set forth in claim 5, wherein the predefined period is equal to or less than (3/16)T

8. The method set forth in one of claims 2 through 4, wherein the position of a first pulse among write pulses for forming a mark 2T and/or 3T in length is adjusted.

9. The method set forth in one of claims 2 through 4, wherein the width of a last pulse among write pulses for forming marks 3T or more in length is adjusted.

10. The method set forth in claim 9, wherein the width of the last pulse is made to be equal for all write pulses for forming marks 4T or more in length.

11. The method set forth in one of claims 2 through 4, wherein a trailing edge cooling time deviation among write pulses for forming marks 2T or more in length is adjusted.

12. The method set forth in claim 11, wherein the trailing edge cooling time deviation is made to be equal for all write pulses for forming marks 4T or more in length.

13. The method set forth in claim 1, wherein the first pulse among write pulses for forming marks 2T or more in length and the last pulse among write pulses for forming marks 3T or more in length are adjusted so that the first pulse and the last pulse, respectively, start ahead of the rising edge of the reference clock therefor.

14. The method set forth in claim 13, wherein the widths or levels of one or more pulses of the multi pulses including the leading pulse of the multi pulses or the widths or levels of all the multi pulses among the write pulses for forming marks 4T or more in length are increased.

15. The method set forth in claim 13 or claim 14, wherein the position of the last pulse is made to be equal for all write pulses for forming marks 4T or more in length.

16. The method set forth in claim 13 or claim 14, wherein the width of the last pulse among write pulses for forming marks 3T or more in length is adjusted.

17. The method set forth in claim 16, wherein the width of the last pulse is made to be equal for all write pulses for forming marks 4T or more in length.

18. The method set forth in claim 1, wherein the phase change optical disk is one of a writable CD, a writable DVD, and a writable Blu-ray Disk (BD).

19. A recording medium, the recording medium having marks or spaces formed by write pulses, which are characterized in that the interval between a first pulse and multi pulses among the write pulses for forming predetermined marks in length is increased within a predefined limit if the write pulses for forming each mark comprise pulses the number of which is one less than the corresponding mark length.

20. The recording medium in claim 19, wherein the multi pulses are adjusted so that one or more pulses of the multi pulses including the leading pulse of the multi pulses among the write pulses for forming predetermined marks in length, respectively, starts behind the rising edge of the reference clock therefor.

21. The recording medium in claim 19, wherein the multi pulses are adjusted so that all of the multi pulses among the write pulses for forming predetermined marks in length, respectively, start behind the rising edge of the reference clock therefor.

22. The recording medium in claim 20 or 21, wherein the widths or levels of the multi pulses that start behind the rising edge of the reference clock therefor are increased.
